(19) United States
(12) Patent Application Publication
(10) Pub. No.: US 2017/0137743 A1
(43) Pub. Date: May 18, 2017

(54) Process for Making Fragrance Compositions

(71) Applicant: The Procter & Gamble Company, Cincinnati, OH (US)

(72) Inventors: Sarah Noelle ABSHER, Cincinnati, OH (US); William James WHITTAKER, Addlestone (GB); Anna Frances GALLOWAY, Killingworth (GB); Wundriari Hagnyono Arif HOFFMANN, Camberley (GB)

(21) Appl. No.: 15/354,181

(22) Filed: Nov. 17, 2016

Related U.S. Application Data
(60) Provisional application No. 62/256,123, filed on Nov. 17, 2015.

(51) Int. Cl. C11B 9/00

(52) U.S. Cl. CPC C11B 9/0003

(57) ABSTRACT

A process of making fragrance compositions by adding solvents with different polarity before and after a filtering step to accelerate precipitation of e.g. waxy carry-overs from perfume oils.

### FIELD OF THE INVENTION

The present invention relates to methods of making fragrance compositions on a commercial scale, specifically involving a chemical solubility mechanism for accelerating precipitation transformation.

### BACKGROUND OF THE INVENTION

A fragrance composition, such as perfume, is typically made in a batch making process using vessels, such as a batch mixing tank, equipped with a standard agitator or high shear mixing device. Generally detailing the classic batch manufacturing approach, a first step has solvents (e.g., ethanol, water) and non-polar ingredients (e.g., perfume oils) added to the mixing tank, per a defined recipe. As the next step, adjunct ingredients (e.g., UV stabilizers, non-perfume oil mixtures, etc.), if present, are added directly to the mixing tank, or alternatively to a slurry tank first then added to the mixing tank. The perfume oils, used to make fragrance composition, contain high levels of natural ingredients that contain waxy carry-overs which are soluble in the perfume oils. However, mixing non-polar perfume oils with the ethanol-water solvent system causes the waxes to precipitate out of solution. Precipitation in the final product is viewed as a consumer end user negative and needs to be completely removed from the product before packaging. As a result, a lengthy residence time (e.g., from 15 minutes to 1.5 hours) and/or chilling step is critical with the classic batch making process to allow for sufficient mixing in order for complete formation of the precipitated waxes. The product is chilled from ambient temperature to 0° C. and then filtered to remove the undesirable wax precipitates formed during the batch making process. Furthermore, after filtering, an optional step of adding other non-polar ingredients to the finished product, for example, dyes for aesthetic purposes, is desirable. It is generally not possible to add the non-polar dyes in advance of the filtering step because the dyes would also fall out of solution during chilling, much like the waxy carry-overs.

There are at least one of several potential drawbacks to the above described batch process. Firstly, the typical batch making process is time-consuming and can take about 4-6 hours to produce about 1.5 tonnes of product. The bulk of the batch cycle is attributable to the residence time needed for mixing and/or chilling to precipitate the wax from solution. Secondly, the batch making process requires the time-consuming, capital intensive, and energy intensive chilling step in order to allow for removal of the undesirable non-polar ingredients (e.g., waxy precipitates from the perfume oils) before the addition of the desirable adjunct ingredients (e.g., dyes). Therefore, there remains a need for a fragrance composition making methodology that is capable of saving capital investment and energy cost, or at least minimizing energy costs attributable to refrigeration or reduce the time attributable to chilling.

### SUMMARY OF THE INVENTION

The present invention addresses one or more these needs. Surprisingly, applicants have discovered the lengthy precipitation transformation time associated with a classic batch process for making a fragrance composition can be accelerated by a chemical solubility mechanism. The manufacturing process of the present invention provides significant cost saving resulting from capital investment and energy savings by the elimination, or at least minimization, of the chilling step (i.e., no heat exchangers, and/or cooling utilities).

In a first aspect, the present invention is directed to a process for making a fragrance composition, comprising the steps of:
(a) providing a non-polar ingredient comprising a perfume oil;
(b) providing a pre-filtration solvent comprising a first ethanol addition and a first water addition;
(c) mixing the non-polar ingredient and the pre-filtration solvent in a batch mixing vessel to make a pre-filtration mixture containing precipitates;
(d) filtering the pre-filtration mixture containing precipitates to remove the precipitates to make a filtered solution; and
(e) adding a post-filtration solvent comprising a second ethanol addition to the filtered solution to make the fragrance composition.

A second aspect of the invention provides for a fragrance composition obtained by the inventive process. A third aspect of the invention provides a fine fragrance product obtained by bottling the fragrance composition made by the inventive process.

It is an advantage of the invention to remove undesirable non-polar ingredients but also add desirable adjunct ingredients without requiring a chilling step, or at least minimizing the chilling step. It is a further advantage to minimize capital costs. It is a further advantage to reduce the manufacturing area footprint at the manufacturing site. It is a further advantage to minimize energy costs (e.g., refrigeration).

These and other features of the present invention will become apparent to one skilled in the art upon review of the following detailed description when taken in conjunction with the appended claims.

### BRIEF DESCRIPTION OF THE DRAWINGS

While the specification concludes with claims particularly pointing out and distinctly claiming the invention, it is believed that the invention will be better understood from the following description of the accompanying figures wherein:

FIG. 1 is a flow diagram for a process for making fragrance composition according to the invention.

### DETAILED DESCRIPTION OF THE INVENTION

### Definition

As used in herein, the articles “a”, “an”, and “the” mean “one or more.”

As used herein, any of the terms “comprising”, “having”, “containing”, and “including” means that other parts, steps, etc. which do not adversely affect the end result can be added. Each of these terms encompasses the terms “consisting of” and “consisting essentially of”. Unless otherwise specifically stated, the elements and/or equipments herein are believed to be widely available from multiple suppliers and sources around the world.

As used herein, the term “batch process” means a manufacturing process in which final product composition, or a portion of a final product composition, or precursor thereof, is produced stage-by-stage over a series of workstations. In fragrance manufacturing, a batch process refers to pilot-scale process or preferably a commercial-scale process. This is contrast to a laboratory scale. For example, a batch process is typically conducted to yield final fragrance compositions weighing at least 5 kg, preferably 10 kg, more preferably 20 kg, yet more preferably at least 50 kg or more.

As used herein, the term “fragrance composition” refers to a composition comprising at least 0.1%, by weight of the composition, of a perfume raw material and at least 10% by weight of the composition of an aqueous-ethanol solvent intended for application to a target surface to impart a pleasant odor thereto, or cover a malodor thereof. Non-limiting examples of a target surface include air (e.g., air freshener), hard surfaces (e.g., floors and countertops), soft surfaces (e.g., carpets and fabric), or body surfaces (e.g., hair and skin). The fragrance composition can be in the form of a final product composition or incorporated as only a portion of a final product composition. These final product compositions may include fine fragrance products, beauty care products, personal care products, fabric care products, home care products, and the like. Preferably the product composition is a fine fragrance product.

As used herein, the term “fine fragrance product” means a fragrance composition comprising at least a perfume raw material and greater than 50% by weight of the fragrance composition of alcoholic solvent, intended to be applied to a target surface, wherein the target surface is a body surface and/or fabric surface (e.g., articles of clothing) to impart a pleasant odor thereto, and/or cover a malodor thereof. These fine fragrance products may include perfume concentrates, perfumes, eau de parfums, eau de toilettes, colognes, or body splashes.

As used herein, the term “mixing” refers combining and further achieving a relatively greater degree of homogeneity thereafter. Mixing in a batch process can be conducted by any mixing method used in the art such as agitation or shear mixing. Mixing in an in-line process can be conducted by any mixing method used in the art such as static mixing.

As used herein, the words “preferred”, “preferably” and variants refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

All percentages, parts and ratios are based upon the total weight of the fragrance composition, unless otherwise specified. All such weights as they pertain to listed ingredients are based on the active level and, therefore do not include carriers or by-products that may be included in commercially available materials. The components, including those which may optionally be added, as well as methods for preparation, and methods for use, are described in detail below.

All ratios are weight ratios unless specifically stated otherwise. All temperatures are in Celsius degrees (° C.), unless specifically stated otherwise. All measurements referred to herein are made at 25° C., i.e., room temperature conditions, unless otherwise specified.

### Batch Process

The traditional batch making process for manufacturing fragrance compositions requires a chilling step to allow for formation of the waxy precipitates from the non-polar ingredients (e.g., perfume oils). This chilling step requires expensive cooling utilities to reduce the reaction temperature from ambient temperature to about 0° C., or even lower. In today's environment of diminishing resources, these conditions pose sustainability challenges, and therefore a new manufacturing process is needed.

The present invention provides an inventive process for manufacturing fragrance composition which may eliminate, or at least reduce, the lengthy residence time and/or the chilling step, allowing for processing at room temperature, or at least temperature higher than 0° C., preferably higher than 5° C., more preferably higher than 10° C., providing cost and/or time savings.

Addition of Solvent with Different Polarity

The applicants have surprisingly discovered that the precipitation reaction can be accelerated by a chemical solubility mechanism. In particular, it is possible to accelerate the precipitation reaction by dividing when solvent is added during the batch making process. For example, instead of adding one hundred percent of the solvent (relative to the final fragrance composition) before a filtering step, the total amount of the solvent, with respect to the final fragrance composition, is divided so as to be added at at least two different points during the process for making the fragrance composition, including, before and after the filtering step (i.e., pre-filtration solvent and post-filtration solvent, respectively). For example, if the solvent is an aqueous-alcohol solvent, the polarity of the system (i.e., the solution or mixture obtained during the process) can be modified at different points by providing solvent having different weight ratios of water: alcohol. More relative water, the more polar is the solvent and thus the system. More relative alcohol, the more non-polar is the solvent and the system. Accordingly a more polar system (high ratio of water: alcohol solvent) is able to accelerate precipitation transformation of non-polar waxy precipitates as compared to a more non-polar system. The polarity of the system is subsequently decreased by adding more alcohol into the filtered solution after the step of filtering precipitates.

In an embodiment, the fragrance composition comprises from 50% to 99% or from 75% to 95%, by weight of the total fragrance composition, of the solvent.

In one aspect, the solvent is added at different points in the process for making fragrance compositions. For example, “pre-filtration solvent” means any solvent that is provided before the filtration step of the process herein. As used herein, the term “post-filtration solvent” means any solvent that is provided after the filtration step of the process herein.

Suitable examples of solvent include water and organic solvents such as a low molecular weight alcohol, more preferably C1-C5 alcohol, such as methanol and ethanol, preferably ethanol. Examples of suitable ethanol include: denatured ethanol from a fermented or distillation process from commercially available suppliers ALCODIS (Brussels, BE), Bundesmonopolverwaltung (Offenbach DE), France Alcools (Paris FR), Ineos Europe Ltd. (Grangemouth, UK), SDA BRABANT (Saint Benoite—FR), either from natural feed stocks (i.e., sugars, starch, or cellulose) or synthetic feed stocks.

In an embodiment, the final fragrance composition herein comprises from about 10% to about 78% by weight of the total fragrance composition of ethanol, preferably from about 47 wt % to about 73 wt %.

Preferably the pre-filtration solvent is more polar than the post-filtration solvent. Preferably the post-filtration solvent contains more alcohol on a weight by weight basis than the pre-filtration solvent. In an embodiment, the pre-filtration solvent contains ethanol and water. In an embodiment, the post-filtration solvent contains ethanol only.

In an embodiment, the weight ratio of ethanol to water in the pre-filtration mixture containing precipitates is from 50:50 to 99:1, preferably from 60:40 to 90:10, more preferably from 70:30 to 85:15.

In an embodiment, the weight ratio of the total ethanol in the fragrance composition attributable to the pre-filtration solvent (i.e., the first ethanol addition) versus the post-filtration solvent (i.e., the second ethanol addition) is from 80:20 to 20:80, preferably from 70:30 to 40:60, or more preferably from 60:40 to 50:50.

In an embodiment, the total water in the fragrance composition is at least 80%, preferably at least 90%, more preferably at least 95%, yet more preferably at least 97%, by weight, attributable to the pre-filtration solvent (i.e., the first water addition).

While the above discussion is based on ethanol solvent for purposes of illustration only, it is intended that this approach can be applied by one skilled in the art to other organic solvents, preferably to those solvents having a polarity less than water but nevertheless soluble in water.

While not wishing to be bound by theory, it is believed that when the solvent system comprises an ethanol and water, by lowering the levels of the ethanol added prior to the filtering step, the water concentration is thereby increased to give a reduction in the amount of the ethanol relative to water. Waxes tend to be more chemically insoluble in water versus ethanol given water's higher polarity. As a result, the reduction of ethanol solvent levels during the pre-filtering step results in acceleration of the wax precipitation out of solution. The balance of the ethanol solvent or other non-polar solvents can then be added post the filtering step to complete the recipe.

### Non-Polar Ingredient

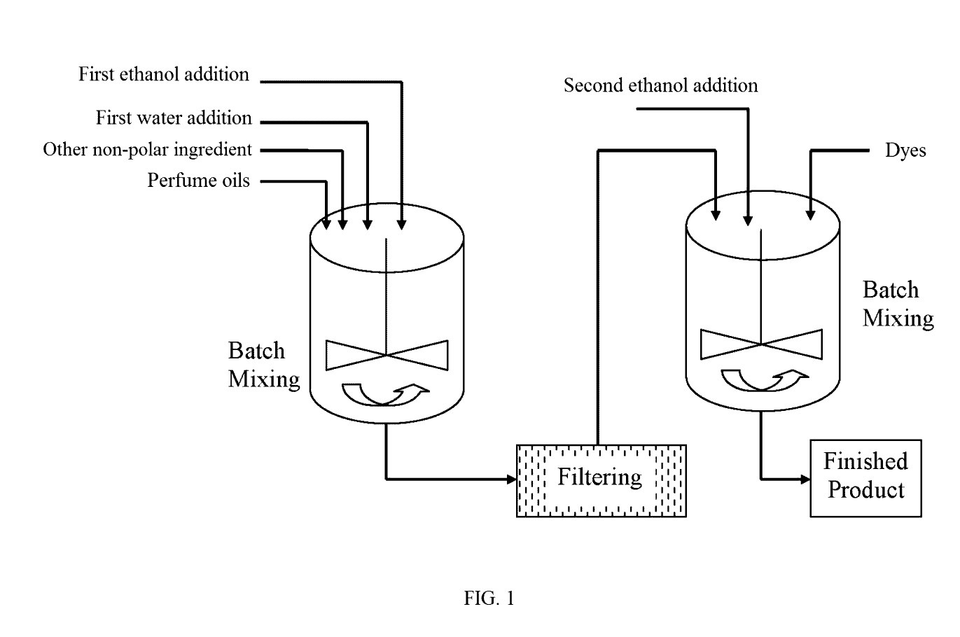

FIG. 1 depicts a diagram illustrating an embodiment of the process for making fragrance composition of the present invention. With reference to FIG. 1, the process comprises a step of providing a non-polar ingredient into a batch mixing vessel. The non-polar ingredient can comprise a perfume oil or a mixture thereof. The non-polar ingredient may further comprise pre-filtration adjunct materials selected from the group consisting of: (a) an oil-based pre-mixture; (b) a non-oil based pre-mixture; and (c) mixtures thereof. The oil-based pre-mixture, in turn, is preferably selected from the group consisting of a UV stabilizer, a skin active, a solubilizer, and combinations thereof. An example of a UV stabilizer may include UVINUL® (from BASF). Preferably, the fragrance composition of the present invention comprises from 0% to 3%, by weight of the total fragrance composition, of the UV stabilizer, more preferably from 0.30 wt % to 1.60 wt %, and even more preferably from 0.30 wt % to 0.60 wt %. The non-oil based pre-mixture, in turn, is preferably selected from the group consisting of a chelating agent, a skin conditioning agent, a cyclodextrin, a pH buffering system, a perfume longevity agent, and combinations thereof.

### Pre-Filtration Solvent

The present process further comprises a step of providing a pre-filtration solvent into the batch mixing vessel. The pre-filtration solvent comprises a first ethanol addition and a first water addition. The pre-filtration solvent may also contain other organic solvents.

The non-polar ingredient comprising a perfume oil and the pre-filtration solvent can be added into the batch mixing vessel in any order of addition or at the same time. In one embodiment, the pre-filtration solvent can be added into the batch mixing vessel subsequent to the addition of the perfume oil. In another embodiment, the first ethanol addition and the first water addition can be added into the batch mixing vessel separately. For example, the first ethanol addition is added into the batch mixing vessel together with the perfume oil and the first water addition is added subsequently to the batch mixing vessel. In another embodiment, the pre-filtration solvent can be added into the batch mixing vessel at several different time points. For example, a portion of the first ethanol addition and optional a portion of the first water addition are added into the batch mixing vessel together with the perfume oil, and the remaining amount of the first ethanol addition and the first water addition are subsequently added. In yet another embodiment, the first ethanol addition and the first water addition are pre-mixed in a pre-mixing container in a desired weight ratio before being added into the batch mixing vessel. In those embodiments where non-perfume oil ingredient (e.g. UV stabilizer) is present, the non-perfume oil ingredient can be added into the batch mixing vessel prior to, during, or after the addition of the perfume oil. In one embodiment, the non-perfume oil ingredient is added into the batch mixing vessel during or after the mixing step (c).

### Mixing

The present process comprises a step of mixing the non-polar ingredient and the pre-filtration solvent in a batch mixing vessel. The mixing step subjects the non-polar ingredient and the pre-filtration solvent to enough mixing energy to produce a pre-filtration mixture containing precipitates (e.g., waxy precipitation from the perfume oils). By using a relatively polar solvent in the mixing step, the precipitation reaction is accelerated and the residence time for the mixing step is reduced. Preferably, the residence time for the mixing step (c) of the present invention is less than 30 minutes, preferably less than 25 minutes, more preferably less than 20 minutes, and even more preferably from 2 minutes to 15 minutes.

The mixing can be performed by using any mixing method used in the art, such as agitation (e.g., mechanical agitation or gas-flow agitation) or shear mixing. In one embodiment, the mixing is done by a high shear mixer, which comprises of a rotor-stator mounted on a driveshaft with an overhead drive unit. In another embodiment, the batch mixing vessel is provided with impeller blades mounted on a driveshaft with an overhead drive unit. A wide variety of blade designs may be used and typically the blades cover about two thirds of the diameter of the mixing vessel. In another embodiment, the batch mixing vessel may also use baffles (not shown). Baffles are stationary blades which break up flow caused by a rotating agitator. Baffles may be fixed to the batch mixing vessel cover or mounted on the interior surface of the side walls of the vessel.

### Optional Turbidity Assessment Before Filtration

The process may include the optional step of assessing turbidity of the pre-filtration mixture containing precipitates with a turbidity meter (with the objective of quantifying the amount precipitates) before the filtering step.

### Filtering

The process comprises a step of filtering the pre-filtration mixture containing precipitates through a filter to remove the precipitates to provide a filtered solution.

The filtering step is accomplished by subjecting the pre-filtration mixture containing precipitates through one or more filters to provide a filtered solution. Non-limiting examples of suitable filters include a lenticular filter or a cartridge filter. Preferably the filter has a pore size having an average diameter of from 1 μm to 10 μm, preferably from 1 μm to 3 μm, or alternatively from 2 μm to 3 μm. A non-limiting example of a suitable filter is a cartridge filter commercially available from PALL Profile Star polypropylene Filter, 3.0 μm KA3A030P1, or Carlson Lenticular cellulose Filters, ID XE50H, LC 1216G.

The one or more filters can be provided in piping in-between a first batch mixing vessel (i.e., where the non-polar ingredient and the pre-filtration solvent are mixed) and a second batch mixing vessel. The first batch mixing vessel and the second batch mixing vessel are in fluid communication via the piping (as shown in FIG. 1). In this arrangement, the mixture containing precipitates from the first batch mixing vessel is filtered through the one or more filters to remove the precipitates to make a filtered solution, wherein the filtered solution then enters into the second batch mixing vessel. A vacuum pump or gravity feed or the like is used to draw the mixture containing precipitates through the filter(s). Alternatively, the one or more filters can be provided in piping forming a recirculation loop (not shown) into and from a single batch mixing vessel. In such way, the mixture containing precipitates from the batch mixing vessel is filtered through the one or more filters to remove the precipitates and the filtered solution flows back into the batch mixing vessel. A vacuum pump or gravity feed or the like is used to draw the mixture containing precipitates through the filter(s).

### Optional Turbidity Assessment After Filtration

The process may further include an optional step of assessing turbidity of the filtered solution with a turbidity meter (with the objective of quantifying the amount precipitates, if any) after the filtering step. The results of the turbidity before filtration can be compared to that of the turbidity of the filtered solution (to see how effective the filtering is in removing the precipitates). The results can also be used as a quality control check in the process of making the fragrance compositions.

### Post-Filtration Solvent

The present process may further comprise a step of adding a post-filtration solvent into the filtered solution to make the fragrance composition. The post-filtration solvent contains a second ethanol addition. The post-filtration solvent may be added into the filtered solution either in line or in the batch mixing vessel or even a second mixing vessel. For example, the post-filtration solvent can be added into a stream line of the filtered solution through a side line. In one embodiment, the post-filtration solvent further comprises a second water addition. In another embodiment, the weight ratio of the total water in the fragrance composition attributable to the first water addition versus the second water addition is from 99.9:0.1 to 80:20, preferably from 99:1 to 95:5.

### Adjunct Ingredient

The present process may comprise a further step of adding an adjunct ingredient to the filtered solution. Preferably, the adjunct ingredient addition is subsequent to the post-filtration solvent addition step, and more preferably, the adjunct ingredient addition step is immediately subsequent to the post-filtration solvent addition step. Preferably, the adjunct ingredient is selected from the group consisting of a dye, colorant, and combination thereof.

### Optional Second Mixing

The process may further comprise an optional step of mixing the filtered solution with the addition of post-filtration solvent to make the fragrance composition (i.e., a second mixing step). The second mixing step subjects the filtered solution to enough mixing energy to produce a mixed solution of uniform dispersion.

Preferably, this second mixing step is followed subsequent to the adjunct ingredient addition step.

This second mixing step can be conducted either in line, or in a batch using a batch mixing vessel (either a first or a second batch mixing vessel) with agitation arrangement as described above. In one embodiment, the mixing is performed in line using a static mixer. An example of a suitable static mixer is one commercially available from Lotus Mixers, Inc. (Nokomis Fla.) under the product name “SL static mixer”, or from Sulzer Ltd., under the product name “Static Mixer Type SMX”. Suitable residence time for this in-line mixing step is from greater than 0 minute to 10 minutes, preferably from 0.1 seconds to 2 minutes, or more preferably eliminated or negligible (i.e., less than 1 second).

### Reducing Temperature/Time of Chilling Step

In one embodiment, the optional chilling step can last for less time (compared to traditional approaches) or the system can be chilled to a relatively high temperature, e.g., greater than 0° C., which minimizes energy costs relative to classic chilling steps below these temperatures. Preferably, the process of the present invention is conducted at a temperature of no less than 10° C., alternatively at ambient temperature. When an optional chilling step is employed, it is provided before the filtering step. In an embodiment, the chilling step is after the mixing step (c). In another embodiment, the chilling step can be provided before the mixing step (c). In an alternative embodiment, the pre-filtration solvent is cooled down (i.e., less than 10° C.) before adding into the batch mixing vessel.

### Eliminating Chilling Step

More preferably, the present process is free of any chilling step. The solubility mechanism helps to accelerate the precipitation of the waxes from the perfume oils thereby eliminating the chilling step. Accordingly, it is an advantage of the invention to minimize capital costs and to reduce the manufacturing area footprint at the manufacturing site otherwise associated with equipment for refrigeration.

### Perfume Oils

A non-polar ingredient comprises a perfume oil. In turn, “perfume oil” contains one or more perfume raw materials (PRMs), that are used to impart an overall pleasant odor or fragrance profile to the fragrance composition. Perfume oils can encompass any suitable PRM for fragrance uses, including chemical materials such as, for example, alcohols, aldehydes, ketones, esters, ethers, acetates, nitriles, terpene hydrocarbons, nitrogenous or sulfurous heterocyclic compounds and essential oils. An example source of perfume oils is naturally occurring plant and animal oils and exudates. The individual PRMs which comprise a known natural oil can be found by reference to Journals commonly used by those skilled in the art such as “Perfume and Flavourist” or “Journal of Essential Oil Research”, or listed in reference texts such as the book by S. Arctander, Perfume and Flavor Chemicals, 1969, Montclair, N.J., USA and more recently re-published by Allured Publishing Corporation Illinois (1994).

Additionally, some PRMs are supplied by the fragrance houses (Firmenich, International Flavors & Fragrances, Givaudan, Symrise) as mixtures in the form of proprietary specialty accords. Non-limiting examples of the fragrance materials useful herein include pro-fragrances such as acetal pro-fragrances, ketal pro-fragrances, ester pro-fragrances, hydrolyzable inorganic-organic pro-fragrances, and mixtures thereof. The fragrance materials may be released from the pro-fragrances in a number of ways. For example, the fragrance may be released as a result of simple hydrolysis, or by a shift in an equilibrium reaction, or by a pH-change, or by enzymatic release. Preferably, the fragrance composition herein comprises from 0.1% to 40%, by weight of the total fragrance composition, of a PRM, more preferably from 2.5 wt % to 25 wt %, and even more preferably from 5 wt % to 15 wt %.

### Fragrance Composition

Preferably, the process of the present invention provides a fragrance composition which is free of any precipitates of the waxy carry-overs of the perfume oils. More preferably the fragrance composition comprises:
(i) from 0.1 wt % to 40 wt % of a perfume raw material, preferably from 5 wt % to 15 wt %;
(ii) from 10 wt % to 90 wt % of ethanol, preferably from 45 wt % to 85 wt %; and
(iii) one or more optional adjunct ingredients to the balance, wherein the wt % is relative to the total weight of the fragrance composition.

Optionally, the fragrance composition further comprises:
(iv) from 0.01 wt % to 50 wt % of water, preferably from 0.1 wt % to 40 wt %, alternatively from 1 wt % to 10 wt %, alternatively from 20 wt % to 40 wt %, wherein the wt % is relative to the total weight of the fragrance composition.

In one aspect of the invention, a fine fragrance product is obtained by bottling the fragrance composition obtained by the inventive process described herein.

### Test Methods

### Test Method 1: Turbidity Test

Precipitation of the waxy carry-overs from the reaction between the ethanol/water solvent system and the perfume oils during the process of the present invention and a classic batch making process can be measured on the basis of turbidity using a Kemtrak TC007 Industrial Turbidimeter (Sweden). Turbidity of the fragrance composition can be measured (in mg/L) at 25° C. between 0.01 NTU (Number of Turbid Units) to 10.0 NTU and at the measuring points as set out in Table 1 herein below.

TABLE 1
Turbidity Measurement Points

| No. | Process Type | Measurement Point |
|---|---|---|
| 1 | Present Process | After the filtering step (d). |
| 2 | Present Process | After the post-filtration solvent addition |
| | | step (e). |
| 3 | Classic Batch | After the chilling step. |
| | Making Process | |
| 4 | Classic Batch | After the filtering step. |
| | Making Process | |

The turbidity of the fragrance composition after the filtering step of the process of the present invention is preferred to be comparable versus that of the fragrance composition obtained by the classic batch-making process which contains a chilling step (to accelerate wax precipitation).

### Test Method 2: Transmittance Test

Transmittance of the fragrance composition can be measured to check the completion of the precipitation of the waxy carry-overs from the reaction between the ethanol/water solvent system and the perfume oils. A suitable spectrometer is Milton Roy Spectronic 601.

### EXAMPLE

The following examples are provided to further illustrate the present invention and are not to be construed as limitations of the present invention, as many variations of the present invention are possible without departing from its spirit or scope.

### Example

### Fragrance Compositions

Table 2 herein shows non-limiting examples A to D of formulations of fragrance compositions that could be obtained by the process of the present invention.

TABLE 2
Fragrance Compositions

Composition (wt %)¹

| Ingredient | A | B | C | D |
|---|---|---|---|---|
| First ethanol | 47.5 | 51.0 | 52.5 | 37.5 |
| addition | | | | |
| Water | 2.5 | 9.0 | 22.5 | 37.5 |
| Perfume oil* | 20.0 | 10.0 | 7.00 | 3.00 |
| Uvinul^{‡} | 0.30 | 1.60 | 0.30 | 0.30 |
| Non-oil based pre- | 0.0 | 0.0 | 0.85 | 3.75 |
| mixture | | | | |
| Second ethanol | 29.7 | 27.65 | 16.85 | 17.95 |
| addition | | | | |
| Dyes | 0.0 | 0.75 | 0.0 | 0.0 |
| Total | 100.00 | 100.00 | 100.00 | 100.00 |
| Residence time | 20 | 15 | 10 | 5 |
| (Mins) | | | | |

*Supplied by Givaudan, IFF or Firmenich.
^{‡}Supplied by BASF.
¹Wt % is relative to the total weight of the fragrance composition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a fragrance composition, comprising the steps of:
(a) providing a non-polar ingredient comprising a perfume oil;
(b) providing a pre-filtration solvent comprising a first ethanol addition and a first water addition;
(c) mixing the non-polar ingredient and the pre-filtration solvent in a batch mixing vessel to make a pre-filtration mixture containing precipitates;
(d) filtering the pre-filtration mixture containing precipitates to remove the precipitates to make a filtered solution; and
(e) adding a post-filtration solvent comprising a second ethanol addition to the filtered solution to make the fragrance composition.

2. The process of claim 1, wherein the weight ratio of ethanol to water in the pre-filtration mixture containing precipitates is from 50:50 to 99:1.

3. The process of claim 1, wherein the weight ratio of the total ethanol in the fragrance composition attributable to the first ethanol addition versus the second ethanol addition is from 80:20 to 20:80.

4. The process of claim 1, wherein the total water in the fragrance composition is at least 80 wt % attributable to the first water addition.

5. The process of claim 1, wherein the post-filtration solvent further comprises a second water addition, and wherein the weight ratio of the total water in the fragrance composition attributable to the first water addition versus the second water addition is from 99.9:0.1 to 80:20, respectively.

6. The process of claim 1, wherein filtering is with a filter having a pore size with an average diameter of from 1 μm to 10 μm.

7. The process of claim 1, wherein residence time for the mixing step (c) is no more than 30 minutes.

8. The process of claim 1, comprising a further step of adding an adjunct ingredient to the filtered solution.

9. The process of claim 8, wherein the adjunct ingredient is selected from the group consisting of dyes, colorants, and a mixture thereof.

10. The process of claim 1, wherein the temperature of the process is never below 10° C.

11. The process of claim 1, wherein the fragrance composition is free of any precipitates, and wherein the fragrance composition comprises:
(i) from 0.1 wt % to 40 wt % of a perfume raw material;
(ii) from 10 wt % to 90 wt % of ethanol; and
(iii) one or more optional adjunct ingredients to the balance,
wherein the wt % is relative to the total weight of the fragrance composition.

12. The process of claim 11, wherein the fragrance composition further comprises:
(iv) from 0.01 wt % to 50 wt % of water, wherein the wt % is relative to the total weight of the fragrance composition.

13. The process of claim 1, wherein the precipitates are waxes from the perfume oil.

14. A fragrance composition obtained by the process according to claim 1.

15. A fine fragrance product obtained by bottling the fragrance composition of claim 14.
